(19) United States
(12) Patent Application Publication
(10) Pub. No.: US 2015/0158597 A1
(43) Pub. Date: Jun. 11, 2015

(54) EMERGENCY POWER GENERATION VIA LIMITED VARIABLE PITCH FAN BLADE

(71) Applicant: UNITED TECHNOLOGIES CORPORATION, Hartford, CT (US)

(72) Inventors: Gabriel L. Suciu, Glastonbury, CT (US); Wesley K. Lord, South Glastonbury, CT (US)

(21) Appl. No.: 14/553,793

(22) Filed: Nov. 25, 2014

Related U.S. Application Data
(60) Provisional application No. 61/914,117, filed on Dec. 10, 2013.

(51) Int. Cl. B64D 41/00; F02C 3/107; B64C 11/30; F02K 3/075; F01D 21/14

(52) U.S. Cl. CPC B64D 41/007; F02K 3/075; F01D 21/14; B64C 11/30; F02C 3/107

(57) ABSTRACT

A method of generating emergency power includes identifying a power-loss condition. In the power-loss condition, a desired quantity of power is determined Emergency power is generated from a turbofan section of the aircraft's engine. The turbofan has a plurality of blades, which have a variable pitch that can be adjusted as a function of the desired quantity of power and actual generated emergency power.

### BACKGROUND

Modern aircraft generate power using a generator driven by the aircraft engines during normal operating conditions. The generator is typically coupled with the high pressure spool of the engine. The high pressure spool provides a stable, predictable quantity of power during normal operation of the engine.

In some cases, such as when an aircraft runs out of fuel or the fuel of the aircraft is contaminated, all of the engines of the aircraft may be put out of service. In the event of such a power-loss condition, alternative power sources are needed to ensure essential functions of the aircraft continue normally. One device used to generate such emergency power is a Ram Air Turbine (RAT). The RAT is often a multi-vane structure on an arm extending from the aircraft that extracts energy from the ram air stream. The ram air stream passing over the RAT can be harnessed to produce either electrical and/or hydraulic power.

A RAT adds weight and takes up limited space on board the aircraft. Furthermore, a RAT provides a level of power proportional to the cube of the speed of the ram air stream. During a low air speed power-loss condition, such as some emergency landings, the RAT may produce lower power.

### SUMMARY

A gas turbine engine has a low pressure spool and a high pressure spool. The low pressure spool has a fan section with a plurality of adjustable fan blades. The high pressure spool is configured to co-rotate with the low pressure spool during a power-loss condition. A controller adjusts the pitch of the plurality of fan blades during the power-loss condition to generate a desired quantity of power.

### BRIEF DESCRIPTION OF THE DRAWINGS

FIG. 1 is a cross-sectional view of a gas turbine engine capable of generating emergency power during a power-loss condition, according to an embodiment.

FIG. 2 is a cross-sectional view of a variable pitch fan blade and actuation mechanism, according to an embodiment.

FIG. 3 is a flowchart illustrating a method of generating power from a variable pitch fan blade during a power-loss condition, according to an embodiment.

### DETAILED DESCRIPTION

A fan section of a gas turbine engine has variable blades that can be adjusted. High and low pressure spools of the aircraft can be coupled so that the low spool (which includes the fan section) drags the high spool (which may be attached to a generator). During a power-loss condition, the pitch of the variable blades is adjusted in order to extract sufficient power from the surrounding ram air stream to operate the essential functions of the aircraft. The fan section drives the low spool, which in turn drags the high spool, which runs the generator. In this way, more energy can be removed from the ram air flow than with a typical windmilling fan section, without requiring the use of a Ram Air Turbine (RAT).

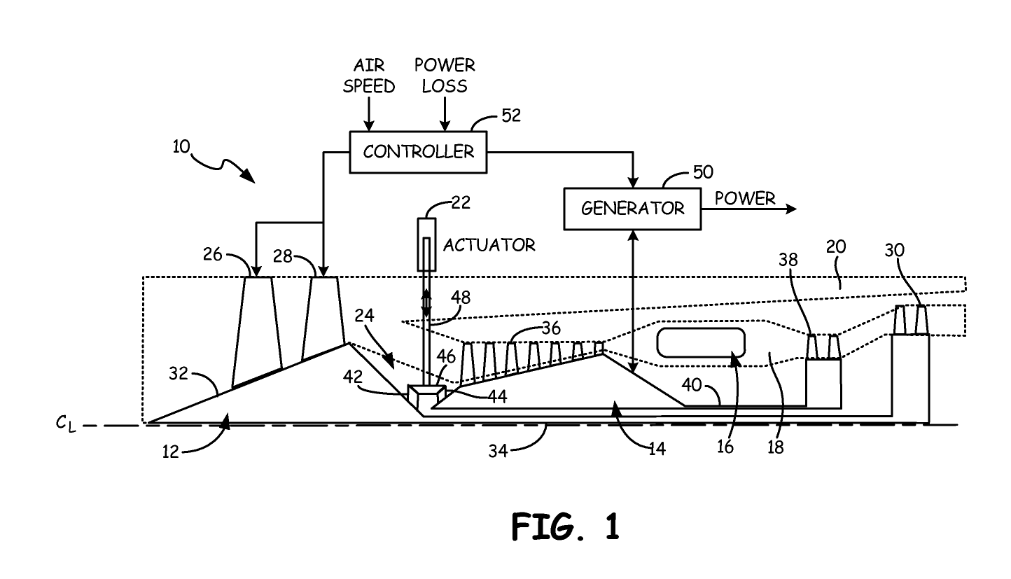

FIG. 1 is a cross-sectional view of gas turbine engine 10 illustrating a system for joining low pressure spool 12 to high pressure spool 14, according to an embodiment. Gas turbine engine 10 includes low spool 12, high spool 14, combustor 16, main flow path 18, fan bypass flow path 20, actuator 22, and gear system 24. Low spool 12 includes fan first stage 26, fan second stage 28, low pressure turbine 30, and fan hub 32, all mechanically connected by low pressure shaft 34. In the embodiment shown in FIG. 1, low spool 12 includes a low pressure compressor, and is mechanically connected to fan first stage 26 and second fan stage 28 via a reduction gear system 24. High spool 14 includes high pressure compressor 36 and high pressure turbine 38, mechanically connected by high pressure shaft 40. Low spool 12 and high spool 14 each rotate independently about centerline axis C_{L} in operation, except when gear system 24 is engaged, as further described below.

Gear system 24 includes bull gear 42, bull gear 44, and bevel (pinion) gear 46. Bull gear 42 is connected to low spool 12 so as to rotate with low spool 12. Bull gear 44 is connected to high spool 14 so as to rotate with high spool 14. Bevel gear 46 is connected to actuator 22 via shaft 48. In an embodiment, shaft 48 is a tower shaft extending substantially radially outward from centerline axis C_{L}. Actuator 22 is positioned radially outward of fan bypass flow path 20. Actuator 22 selectively actuates bevel gear 46 radially inward and outward to engage and disengage bull gears 42 and 44. As illustrated in FIG. 1, bevel gear 46 is in a position engaged with bull gears 42 and 44 such that high spool 14 rotates in a direction opposite that of low spool 12 when low spool 12 rotates. In alternative embodiments, gear system 24 can include additional gears and be configured differently than as illustrated. Gear system 24 can be a reduction gear system allowing low spool 12 to rotate at a different rotational speed from that of high spool 14 when gear system 24 is engaged. In one embodiment, gear system 24 can have a relatively high gear ratio such that high spool 14 (which has a relatively small inertia) can rotate faster than low spool 12 (which has a relatively large inertia) when gear system 24 is engaged. In some embodiments, gear system 24 can have a gear ratio of about 2:1 to about 10:1. In other embodiments, gear system 24 can have any gear ratio suitable for the application.

In an embodiment, generator 50 is coupled to high spool 14. In the embodiment shown in FIG. 1, generator 50 includes an electrical generator. In alternative embodiments, generator 50 may include a hydraulic pump to power a hydraulic system. Generator 50 may be used during normal operation of the aircraft as well as during power-loss conditions in which no engine is operational. Thus, generator 50 provides emergency power without requiring additional hardware that would add to the cost or weight of engine 10.

During normal operation of engine 10, generator 50 is powered by the rotation of high spool 14 caused by core flow past high pressure turbine 38. During a power-loss condition, there is not sufficient core flow past high pressure turbine 38 to drive generator 50. In the power-loss condition, gear system 24 is engaged such that low spool 12 co-rotates with high spool 14. Thus, even during a power-loss condition (such as when no fuel is flowing to combustor 16), high spool 14 is driven by low spool 12, which is driven by first fan stage 26 and second fan stage 28, and generator 50 can supply the energy needed for essential functions of the aircraft.

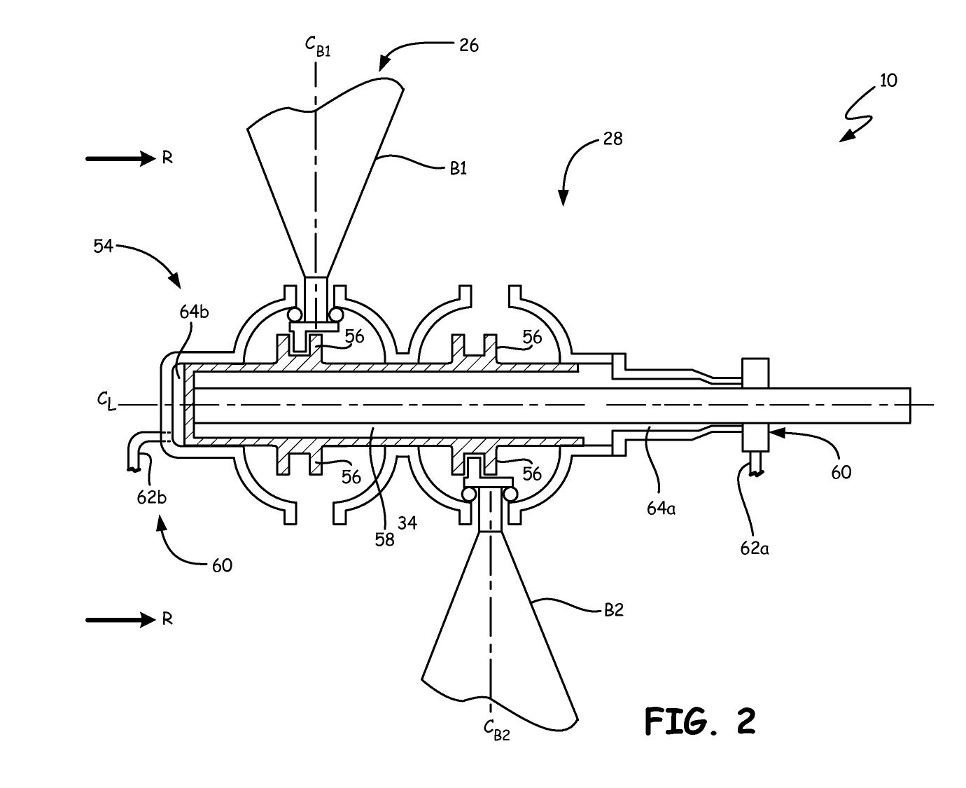

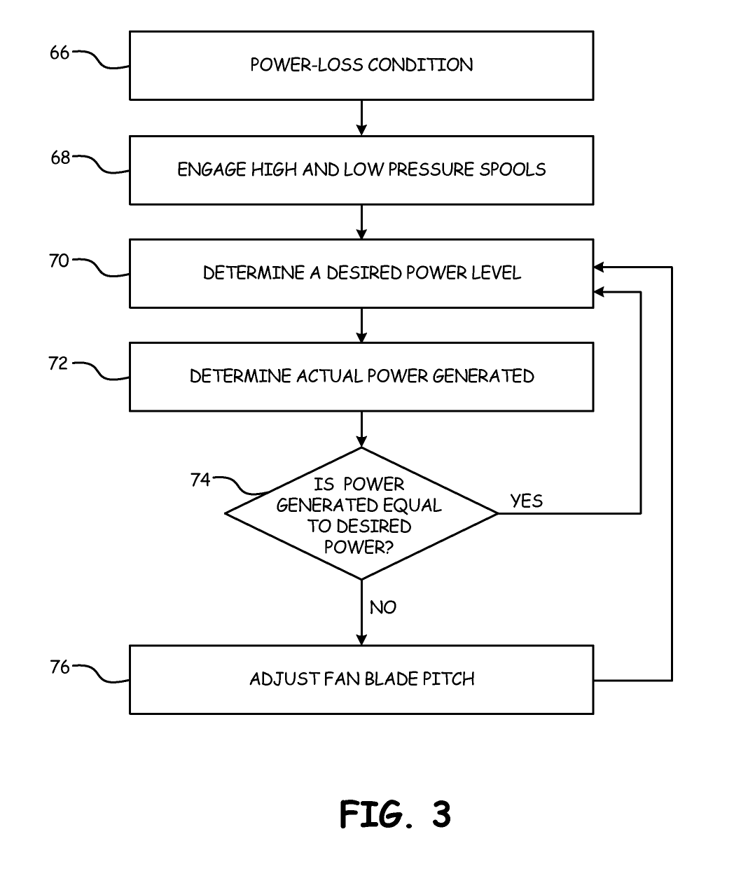

First fan stage 26 and second fan stage 28 each comprise a plurality of blades with adjustable pitch, as described in more detail with respect to FIG. 2. The pitch of first fan stage 26 and second fan stage 28 can be modified by control signals from controller 52. Controller 52 is also configured to receive information regarding the quantity of power generated by generator 50. According to one embodiment, controller 52 determines the appropriate angle for the blades of first fan stage 26 and second fan stage 28 based on input from generator 50, as described in more detail with respect to FIG. 3. In other embodiments, the appropriate blade angle may be determined by air speed of the aircraft, or the rotational speed of the first fan stage 26, or the second fan stage 28.

The embodiment shown in FIG. 1 is merely one way of coupling low pressure spool 12 to high pressure spool 14. It will be understood to those of skill in the art that any coupling device would permit for the use of a variable pitch fan section driving a generator attached to a high pressure spool. In alternative embodiments, a single fan stage may be used, rather than first fan stage 26 and second fan stage 28 shown in FIG. 1. A single fan stage embodiment can drive the low spool, which may be coupled to the high spool and the generator, in much the same way as the two-stage system shown in FIG. 1.

FIG. 2 is a cross-sectional view of a variable pitch fan blade and actuation mechanism 54 for fan blades B1 and B2 of first fan stage 26 and second fan stage 28, respectively. In particular, FIG. 2 illustrates pitch yokes 56, pitch actuator sleeve 58, and hydraulic system 60, including hydraulic fluid tubing 62a and 62b, and hydraulic fluid channels 64a and 64b.

Low pressure shaft 34 rotates about centerline axis C_{L} to drive first fan stage 26 and second fan stage 28. Blade B1 of first fan stage 26 extends perpendicular to centerline axis C_{L} along blade axis C_{B1}. Blade B2 of second fan stage 28 extends perpendicular to centerline axis C_{L} along blade axis C_{B2}. Although only one blade is shown in each stage of the fan (i.e., blade B1 of first fan stage 26 and B2 of second fan stage 28), it is understood that a plurality of blades could be attached to each of first fan stage 26 and second fan stage 28, each of such blades extending along axes perpendicular to centerline axis C_{L}.

Under normal operating conditions, gas turbine engine 10 drives the rotation of first fan stage 26 and second fan stage 28 on low pressure spool 12, as previously described with respect to FIG. 1. Pitch yokes 56 may be moved generally parallel to centerline axis C_{L} to change a pitch of the blades of first fan stage 26 and second fan stage 28. In the embodiment shown in FIG. 2, pitch actuator sleeve 58 is attached to hydraulic system 60. Hydraulic fluid tubing 62a and hydraulic fluid tubing 62b selectively route hydraulic fluid via hydraulic fluid channels 64a and 64b, respectively, to adjust the position of pitch actuator sleeve 58. In other embodiments, the pitch actuator sleeve 58 may be attached to an electric motor or servo which adjusts the position of the pitch actuator sleeve 58. Further, as previously discussed with respect to FIG. 1, in alternative embodiments a single fan stage can be used in place of the two-stage system shown in the embodiment of FIG. 2.

As pitch actuator sleeve 58 moves generally parallel to centerline C_{L}, blades B1 and B2 are rotated, and as a result have a different pitch with respect to ram air flow R. Blades B1 and B2 may be rotated such that their pitch varies by any desired amount from the pitch commonly used at cruise. In some embodiments, the variation from the pitch used at cruise may be up to 20°.

The pitch of blades B1 and B2 may be adjusted depending on a flight phase of the aircraft powered by engine 10. In the event that all power sources are out of service, the pitch of blades B1 and B2 may be adjusted to extract sufficient energy from the ram air flow to drive low spool 12 and high spool 14, generating power as previously described with respect to FIG. 1.

FIG. 3 is a flowchart illustrating a method of generating power from a variable pitch fan blade during a power-loss condition, according to an embodiment.

At block 66, a power-loss condition is identified. Such conditions may occur when fuel runs out or is contaminated, or during mechanical failures of an engine. A power-loss condition is a condition in which no engine is capable of producing sufficient power to sustain the necessary functions of the aircraft, such as operating the flaps, sensors, and landing gear. The power-loss condition is communicated to controller 52 to begin the process of managing emergency power.

At block 68, the high pressure spool and low pressure spools are engaged to co-rotate. As previously described with respect to FIG. 1, an actuator may connect the two spools such that the rotational speeds of the spools are proportional to one another. By ensuring co-rotation of the spools, energy captured by the fan section (which is a part of the low pressure spool) may be transferred to the high pressure spool.

At block 70, a desired power level is determined. The desired power level may be affected by the flight phase of the aircraft, the airspeed of the aircraft, or other factors. One of skill in the art will recognize that the desired power level may vary depending on which loads are being powered. The loads may include landing gear, flaps, emergency radio/transponder, and/or sensors. The desired power level may increase or decrease to account for coupling and decoupling of these loads from the aircraft's electric power bus or hydraulic system. The desired power level may also take into account the aircraft's ability to produce the emergency power; for example, some loads may be decoupled with reduced air speed, so that the fan section of the engine does not stall.

At block 72, the actual power generated is calculated. The actual power generated is a function of the pitch of the fan blades and the airspeed of the aircraft. As the air speed of an aircraft slows, the quantity of power obtained from the windmilling fan section will also decrease. Likewise, as pitch increases to the point where the blade is parallel to the direction of ram air flow, the quantity of power obtained from the windmilling fan section will decrease.

At block 74, the desired power level is compared to the actual power generated. In this way, the power generated is tuned to the level of power needed for the aircraft's functions. This not only facilitates continued service of essential aircraft functions as the aircraft slows (for example, during an emergency landing), but also eliminates the unnecessary drag that would be caused by a fan section with a fixed pitch that was lower than necessary.

If necessary, fan blade pitch is adjusted at block 76. If the actual power generated is lower than the desired power level, the pitch of the adjustable fan blades may be decreased to generate more power, and vice versa. After any adjustments, the desired power level is recalculated, and the process repeats as necessary. Although the present invention has been described with reference to preferred embodiments, workers skilled in the art will recognize that changes may be made in form and detail without departing from the spirit and scope of the invention.

1. A gas turbine engine comprising:
a low pressure spool including:
a low spool shaft; and
a fan section, the fan section comprising a plurality of adjustable fan blades and configured to co-rotate with the low pressure shaft;
a high pressure spool including a high spool shaft, wherein the high pressure spool is configured to co-rotate with the low pressure spool during a power-loss condition;
a generator coupled to the high pressure spool and configured to generate power; and
a controller configured to adjust a pitch of the plurality of adjustable fan blades during the power-loss condition.

2. The gas turbine engine of claim 1, wherein the high pressure shaft is coupled to the low pressure shaft to rotate at least as rapidly as the low pressure shaft in the power-loss condition.

3. The gas turbine engine of claim 1, wherein the controller is configured to determine a desired quantity of power, and adjust the pitch when the generated power for the accessories is not equal to the desired quantity.

4. The gas turbine engine of claim 1, wherein the generator includes an electric generator.

5. A method of generating emergency power for an aircraft during a power-loss condition, the method comprising:
identifying the power-loss condition;
determining a desired quantity of power;
generating emergency power from a turbofan section of an aircraft engine, the turbofan section including a plurality of blades; and
adjusting a pitch of the plurality of blades as a function of the desired quantity of power and the generated emergency power.

6. The method of claim 5, wherein the power-loss condition results from an engine failure.

7. The method of claim 5, wherein the controller adjusts the pitch of a first set of the plurality of blades associated with a first engine to zero in the event of failure of the first engine that does not result in the power-loss condition.

8. The method of claim 5, wherein generating the emergency power comprises driving a generator coupled to a high pressure spool, wherein the high pressure spool is configured to co-rotate with the turbofan section.

9. The method of claim 8, wherein the generator includes an electric generator.

10. The method of claim 8, wherein the generator includes a hydraulic pump.

11. The method of claim 5, wherein adjusting the angle of attack of the plurality of blades comprises:
selectively increasing the pitch to increase the emergency power generated by the fan section; and
selectively decreasing the pitch to decrease the emergency power generated by the fan section.

12. The method of claim 11, wherein the pitch may be increased by up to 20° from a cruise pitch.

13. The method of claim 12, wherein the low spool is coupled to a high spool such that the high spool rotates at least as rapidly as the low spool during the power-loss condition.

14. A method of generating emergency power from a rotating fan section in a power-loss condition of an aircraft, the method comprising:
driving a generator to produce emergency power during the power-loss condition using the rotation of a plurality of fan blades; and
controlling a pitch of the plurality of fan blades as a function of a desired quantity of emergency power and the emergency power generated.

15. The method of claim 14, wherein the pitch is increased when the desired quantity of emergency power generated increases or when the air-speed of the turbofan aircraft decreases.
